(19) United States
(12) Patent Application Publication
(10) Pub. No.: US 2026/0065197 A1
(43) Pub. Date: Mar. 5, 2026

(54) REPORT PROVIDING METHOD AND CONTROL METHOD FOR REPORT PROVIDING SYSTEM

(71) Applicant: SEIKO EPSON CORPORATION, Tokyo (JP)

(72) Inventors: Hideo SASAHARA, SUWA-SHI (JP); Koichi HATANAKA, MATSUMOTO-SHI (JP)

(73) Assignee: SEIKO EPSON CORPORATION, Tokyo (JP)

(21) Appl. No.: 19/312,315

(22) Filed: Aug. 28, 2025

(30) Foreign Application Priority Data
Aug. 30, 2024 (JP) 2024-148572

(51) Int. Cl. G06Q 10/0633; G06Q 50/40

(52) U.S. Cl. CPC G06Q 10/0633; G06Q 50/40

(57) ABSTRACT

According to an aspect of the present disclosure, there is provided a report providing method for providing a report concerning a vehicle to which a sensor is attached, the report including loading rate information concerning a loading rate of the vehicle calculated based on data concerning the vehicle detected by the sensor and a maximum loading capacity of the vehicle, the report providing method including a computer acquiring the report including the loading rate information and displaying the report or printing the report on a medium.

The present application is based on, and claims priority from JP Application Serial Number 2024-148572, filed Aug. 30, 2024, the disclosure of which is hereby incorporated by reference herein in its entirety.

### BACKGROUND

### 1. Technical Field

The present disclosure relates to a report providing method and a control method for a report providing system.

### 2. Related Art

An operation management device described in JP-A-2022-59913 outputs a shipper daily report indicating an operation route of a truck, a work time of a driver for each work item, and the like (see JP-A-2022-59913).

JP-A-2022-59913 is an example of the related art.

However, in the related art explained above, since information concerning a loading rate is not indicated, it is sometimes impossible to urge the driver or a transportation company to achieve efficiency of the loading rate.

### SUMMARY

According to an aspect of the present disclosure, there is provided a report providing method for providing a report concerning a vehicle to which a sensor is attached, the report including loading rate information concerning a loading rate of the vehicle calculated based on data concerning the vehicle detected by the sensor and a maximum loading capacity of the vehicle, the report providing method including a computer: acquiring the report including the loading rate information; and displaying the report or printing the report on a medium.

According to an aspect of the present disclosure, there is provided a control method for a report providing system including: a sensor attached to a vehicle; a report generation unit configured to generate a report based on data detected by the sensor; and a report output unit configured to output the report generated by the report generation unit, the control method including: causing the sensor to acquire data concerning the vehicle; causing the sensor to transmit the acquired data to the report generation unit; causing the report generation unit to acquire a maximum loading capacity of the vehicle; causing the report generation unit to calculate a loading rate of the vehicle based on the data and the maximum loading capacity; causing the report generation unit to generate the report including loading rate information concerning the calculated loading rate of the vehicle; causing the report generation unit to transmit the generated report to the report output unit; and causing the report output unit to display the report or print the report on a medium.

### BRIEF DESCRIPTION OF THE DRAWINGS

FIG. 1 is a diagram illustrating a configuration example of a report providing system according to an embodiment.

FIG. 2 is a diagram illustrating a configuration example of a server device according to the embodiment.

FIG. 3 is a diagram illustrating an example of a situation at the time of movement of a vehicle according to the embodiment.

FIG. 4 is a diagram illustrating an example of temperature and the magnitude of an impact measured at the time of the movement of the vehicle according to the embodiment.

FIG. 5 is a diagram illustrating another example of the situation at the time of the movement of the vehicle according to the embodiment.

FIG. 6 is a diagram illustrating another example of the temperature and the magnitude of the impact measured at the time of the movement of the vehicle according to the embodiment.

FIG. 7 is a diagram illustrating an example of a report according to the embodiment.

FIG. 8 is a diagram illustrating an example of a procedure of processing performed in the report providing system according to the embodiment.

### DESCRIPTION OF EMBODIMENTS

An embodiment is explained below with reference to the drawings.

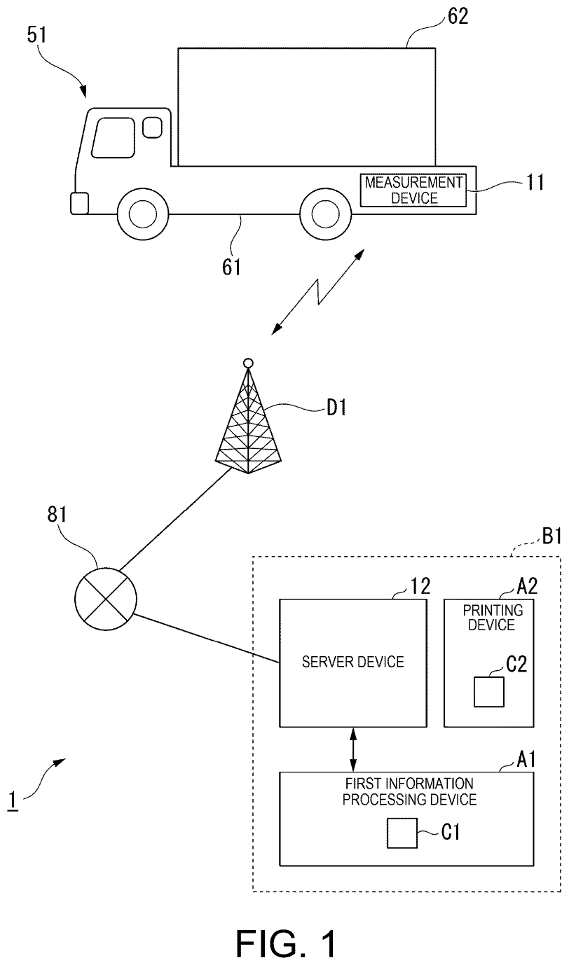

FIG. 1 is a diagram illustrating a configuration example of a report providing system 1 according to the embodiment.

The report providing system 1 includes a measurement device 11, a server device 12, a first information processing device A1, and a printing device A2.

The first information processing device A1 includes a first report output unit C1.

The printing device A2 includes a second report output unit C2.

In FIG. 1, a vehicle 51, a base station device D1, and a network 81 are illustrated.

The network 81 may be, for example, the Internet.

In the example illustrated in FIG. 1, a management unit B1 including the server devices 12, the first information processing device A1, and the printing device A2 is illustrated.

Here, in the present embodiment, the measurement device 11 and the server device 12 communicate via the base station device D1 and the network 81. However, for example, when the measurement device 11 and the server device 12 communicate not via the base station device D1 and the network 81, the report providing system 1 may not include the base station device D1 and the network 81.

The measurement device 11 and the server device 12 may communicate via a not-illustrated relay device together with the base station device D1 or instead of the base station device D1, for example.

As the communication, for example, wireless communication may be used, wired communication may be used, or both of the wireless communication and the wired communication may be used.

In the present embodiment, the first information processing device A1 and the printing device A2 capable of communicating with the server device 12 are provided. However, the first information processing device A1 and the printing device A2 may not be respectively always provided.

In the example illustrated in FIG. 1, when the report providing system 1 does not include the first information processing device A1 and the printing device A2, the management unit B1 is substantially equal to the server device 12.

At least one of functions of the first information processing device A1 and functions of the printing device A2 may be included in the server device 12.

In the present embodiment, the first information processing device A1 and the printing device A2 are separate bodies. However, for example, the first information processing device A1 and the printing device A2 may be integrally configured.

In the present embodiment, the vehicle 51 is a car and is a truck as a specific example. The vehicle 51 generally includes a chassis 61 and a loading platform 62.

Here, for example, the loading platform 62 is detachably attachable to the chassis 61 of the vehicle 51. In the present embodiment, the vehicle 51 transports freight loaded on the loading platform 62 in a state in which the loading platform 62 is attached to the chassis 61.

The measurement device 11 is installed in the vehicle 51.

In the present embodiment, the measurement device 11 is provided by, for example, being mounted on the chassis 61 of the vehicle 51. However, as another example, the measurement device 11 may be provided by, for example, being mounted on the loading platform 62 of the vehicle 51.

Examples of the loading platform 62 on top of the truck include a flat body, a refrigerated freezer, a crane, a van, and a dump truck. The loading platform 62 may be called by any other name.

The measurement device 11 includes one or more sensors that detect a predetermined physical quantity.

Here, the measurement device 11 may include any sensor and may include, for example, two or more sensors.

The measurement device may be called, for example, measurement instrument. For example, when the measurement device is equivalent to one sensor, the measurement device may be called sensor. For example, when the measurement device includes two or more sensors, the measurement device may be called sensor unit or the like.

When the measurement device 11 includes a plurality of sensors, for example, the plurality of sensors may be configured as an integrated device or one or more sensors among the plurality of sensors may be configured as separate bodies.

The measurement may be called, for example, gauging, detection, or sensing.

A value measured by the measurement device 11 may be called, for example, measurement value, detection value, or actual measurement value.

In the present embodiment, the measurement device 11 detects information concerning acceleration, information concerning a gyro, and information concerning a position.

The measurement device 11 transmits the detected information to the server device 12.

Here, the information concerning the acceleration may be detected using, for example, an acceleration sensor. In the present embodiment, a value of an impact may be calculated based on the information concerning the acceleration.

The information concerning the gyro may be detected using, for example, a gyro sensor.

The information concerning the position may be detected using, for example, a sensor of a global navigation satellite system (GNSS).

As a specific example, the measurement device 11 includes a GNSS reception unit, which is the sensor. The GNSS reception unit receives a GNSS signal using a GNSS antenna and acquires the information concerning the position based on the received GNSS signal. Here, the GNSS signal is transmitted from one or more GNSS satellites.

As the GNSS, one or more of, for example, a global positioning system (GPS), GLONASS, Galileo, and BeiDou may be used.

In the present embodiment, the measurement device 11 includes a temperature sensor that detects the temperature of the loading platform 62.

Here, in the present embodiment, in order to simplify explanation, it is assumed that the temperature sensor is provided in the measurement device 11. However, as another example, the temperature sensor may be grasped as a sensor different from the sensor provided in the measurement device 11. When the temperature sensor is grasped as being provided in the measurement device 11, the temperature sensor may be provided at a different part in the vehicle 51 separately from the other sensors of the measurement device 11.

In the present embodiment, the measurement device 11 includes, on or near the loading platform 62, a sound sensor that detects sound.

Here, in the present embodiment, in order to simplify explanation, it is assumed that the sound sensor is provided in the measurement device 11. However, as another example, the sound sensor may be grasped as a sensor different from the sensor provided in the measurement device 11. When the sound sensor is grasped as being provided in the measurement device 11, the sound sensor may be provided at a different part in the vehicle 51 separately from the other sensors of the measurement device 11.

The sound includes voice.

As the sound sensor, for example, a microphone may be used.

In the present embodiment, the vehicle 51 includes a predetermined in-vehicle device as an example of the sensor. The in-vehicle device has, for example, a function of automatically detecting and storing information concerning a highway usage fee. The in-vehicle device has a function of communicating an external network and transmitting the information.

For example, the in-vehicle device may be grasped as not being provided in the measurement device 11 or may be grasped as being provided in the measurement device 11. When the in-vehicle device is grasped as being provided in the measurement device 11, the in-vehicle device may be provided at a different part in the vehicle 51 separately from the other sensors of the measurement device 11.

As another example of a sensor, a camera that images a state in the loading platform 62 may be used in the vehicle 51. The camera may be provided, for example, on the inside of the loading platform 62 or on the outside of the vicinity of the loading platform 62.

For example, the camera may capture a still image or may capture a moving image.

The camera may be, for example, a visible light camera or an infrared camera.

Based on an imaging result of the camera, for example, whether freight is loaded on the loading platform 62 may be determined or an amount of the freight loaded on the loading platform 62, the capacity of the loading platform 62, or the like may be determined.

When the camera explained above is used, for example, the camera may be grasped as not being provided in the measurement device 11 or may be grasped as being provided in the measurement device 11. When the camera is grasped as being provided in the measurement device 11, the camera may be provided at a different part in the vehicle 51 separately from the other sensors of the measurement device 11.

As another example of a sensor, a laser device that detects an object in the loading platform 62 may be used in the vehicle 51. The laser device may be provided, for example, on the inside of the loading platform 62 or on the outside of the vicinity of the loading platform 62.

The laser device irradiates the inside of the loading platform 62 with laser light and detects reflected light of the laser light. Based on the reflected light, for example, whether freight is loaded on the loading platform 62 may be determined or an amount of the freight loaded on the loading platform 62, the capacity of the loading platform 62, or the like may be determined.

For example, the laser device may emit the laser light in one direction or may emit the laser light in each of a plurality of directions. Usually, when there are many directions in which the laser light is emitted, the accuracy of object detection increases.

When the laser device explained above is used, for example, the laser device may be grasped as not being provided in the measurement device 11 or may be grasped as being provided in the measurement device 11. When the laser device is grasped as being provided in the measurement device 11, the laser device may be provided at a different part in the vehicle 51 separately from the other sensors of the measurement device 11.

As another example of a sensor, the vehicle 51 may include, for example, an IMU sensor including an inertial measurement unit (IMU).

The IMU sensor may measure, for example, acceleration and angular velocity.

The server device 12, the first information processing device A1, and the printing device A2 may be respectively operated by predetermined operators or the like.

Here, all of a person who operates the server device 12, a person who operates the first information processing device A1, and a person who operates the printing device A2 may be, for example, different persons, some of the persons may be the same person, or all of the persons may be the same person.

The first information processing device A1 and the server device 12 communicate by wire or radio. In the present embodiment, the first information processing device A1 and the server device 12 are directly connected but, as another example, may be connected via a predetermined base station device and a predetermined network.

The printing device A2 and the server device 12 communicate by wire or radio. In the present embodiment, the printing device A2 and the server device 12 are directly connected but, as another example, may be connected via a predetermined base station device and a predetermined network.

Here, in the present embodiment, for convenience of explanation, one vehicle 51 is exemplified and explained. However, for example, the report providing system 1 according to the present embodiment may be applied to a plurality of vehicles and, in this case, the same processing as the processing in the present embodiment is performed for each of the vehicles. In this case, information concerning each of the plurality of vehicles may be, for example, stored.

For example, when the report providing system 1 according to the present embodiment is applied to a plurality of vehicles, data of a measurement result by a measurement device is managed for each of the vehicles. That is, data of a measurement result by the measurement device of each of the vehicles is stored and, for example, communicated in linkage with one or more of identification information of each of the vehicles, identification information of a chassis of each of the vehicles, identification information of a loading platform of each of the vehicles, identification information of the measurement device of each of the vehicles, identification information of an individual sensor provided in the measurement device of each of the vehicles, and the like.

In the present embodiment, when a measurement device of one vehicle includes a plurality of sensors, data of measurement results of the plurality of sensors is managed to be identifiable as being data of measurement results of the same measurement device. As a specific example, the data of the measurement results of the plurality of sensors provided in the measurement device of the one vehicle may be always stored as a set and, for example, communicated or, when the data of the measurement results of the plurality of sensors provided in the measurement device of the one vehicle is separately treated, the data of the measurement result of each of the sensors may be linked with identification information of the measurement device to which the sensor belongs.

The linkage may be called, for example, association or correlation.

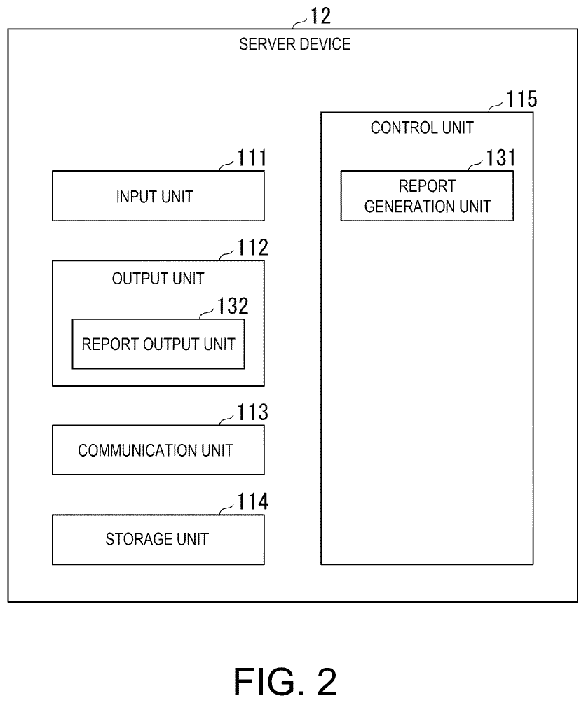

FIG. 2 is a diagram illustrating a configuration example of the server device 12 according to the embodiment.

In the present embodiment, the server device 12 is configured using a computer.

The server device 12 includes an input unit 111, an output unit 112, a communication unit 113, a storage unit 114, and a control unit 115.

The output unit 112 includes a report output unit 132.

The control unit 115 includes a report generation unit 131.

The input unit 111 may have, for example, a function of receiving input of information output from a not-illustrated external device.

When the functions of the first information processing device A1 are incorporated in the server device 12, the input unit 111 may have, for example, a function of receiving input of an instruction or the like based on operation performed by a not-illustrated operator or the like.

The output unit 112 may have, for example, a function of outputting information to the not-illustrated external device.

The report output unit 132 outputs predetermined report information to the external device. The external device may be, for example, one or both of the first information processing device A1 and the printing device A2.

As another example, the external device may be a display screen.

The display screen may be provided in, for example, the server device 12. That is, the server device 12 may output the report information with the report output unit 132 in the own device.

When the functions of the first information processing device A1 are incorporated in the server device 12, the output unit 112 may have, for example, a function of displaying display target information on a not-illustrated display screen.

When the functions of the printing device A2 are incorporated in the server devices 12, the output unit 112 may have, for example, a function of printing print target information on a not-illustrated medium.

The communication unit 113 has a function of performing communication.

In the present embodiment, the communication unit 113 communicates with the measurement device 11 via the network 81 and the base station device D1.

In the present embodiment, the communication unit 113 is illustrated separately from the input unit 111 and the output unit 112. However, for example, a function of a reception unit among the functions of the communication unit 113 may be included in the functions of the input unit 111 and a function of a transmission unit among the functions of the communication unit 113 may be included in the functions of the output unit 112.

The storage unit 114 stores information.

The server device 12 may be configured to perform at least one of using a not-illustrated external database instead of the storage unit 114 or together with the storage unit 114 to store information in the database and acquiring information from the database.

The control unit 115 performs various kinds of processing or controls in the server device 12.

In the present embodiment, the control unit 115 includes a predetermined processor such as a central processing unit (CPU) and executes a control program with the processor to perform the various types of processing or the control.

The control program may be stored in, for example, the storage unit 114.

The report generation unit 131 acquires data necessary for processing.

The report generation unit 131 acquires, for example, data stored in the storage unit 114, data received by the communication unit 113, or input data received by the input unit 111.

The report generation unit 131 generates predetermined report information based on the acquired data. The data may be called information or the like instead.

Here, for example, when generating a report, the report generation unit 131 may refer to and use predetermined delivery information.

The delivery information includes, for example, information concerning a mode of a driver driving the vehicle 51 to deliver freight. As a specific example, the deliver information may include one or more of information concerning the driver, a delivery route, a delivery base, an article of the freight to be delivered, a name of the freight to be delivered, a delivery time schedule, information concerning the vehicle 51 driven by the driver, information concerning the measurement device 11 provided in the vehicle 51, and the like.

The delivery information may be called, for example, transportation information.

The information concerning the vehicle 51 driven by the driver may include one or more of, for example, identification the information of vehicle 51, identification information of the chassis 61, identification information of the loading platform 62, and information concerning a maximum loading capacity of the loading platform 62.

For example, common identification information may be used as the identification information of the vehicle 51 and the identification information of the chassis 61.

The information concerning the measurement device 11 may include one or more of, for example, identification information of the measurement device 11, identification information of a sensor provided in the measurement device 11, and characteristic information of a sensor provided in the measurement device 11.

For example, the delivery information may be stored in advance in the storage unit 114 of the server device 12 or may be input from the first information processing device A1 to the server device 12 at any timing.

As an example, the delivery information may be input to the first information processing device A1 by the operator or the like operating the first information processing device A1 and notified from the first information processing device A1 to the server device 12.

In the present embodiment, the first information processing device A1 is a terminal used by a driver or a transportation company. In this case, the driver or the transportation company is an example of the operator.

The first information processing device A1 is configured using, for example, a computer.

The first information processing device A1 has a function of accessing the server device 12 and communicating with the server device 12, a function of receiving report information transmitted from the server device 12, a function of outputting the report information with the first report output unit C1, and the like. As an aspect of outputting the report information, for example, display output by a screen may be used.

The printing device A2 is configured using, for example, a printing mechanism and a computer.

The printing device A2 has a function of communicating with the server device 12, a function of receiving report information transmitted from the server device 12, a function of printing the report information with the second report output unit C2, and the like.

Processing for determining a loading rate of the vehicle 51 with the report generation unit 131 of the server device 12 is explained.

In the present embodiment, the server device 12 evaluates the loading rate of the vehicle 51 based on information acquired by the measurement device 11.

The loading rate of the vehicle 51 is represented by [{(weight of freight loaded on a vehicle)/(maximum weight that can be loaded on the vehicle)}×100].

Here, the maximum weight that can be loaded on the vehicle 51 is equivalent to a maximum loading capacity of the vehicle 51 and, in the present embodiment, is equivalent to a maximum loading capacity of the loading platform 62 of the vehicle 51.

As the loading rate is higher, the transportation company can more easily gain a profit. For this reason, it is possible to contribute to businesses by, for example, notifying the loading rate from the server device 12 to the transportation company and reviewing the loading rate in the transportation company.

Here, in the present embodiment, the report generation unit 131 of the server device 12 stores a learning model of machine learning for determining the loading rate of the vehicle 51.

As an example, a learning model for determining a loading rate may be created by procedures P1 to P5 explained below.

In the procedure P1, the measurement device 11 acquires predetermined measurement data while the vehicle 51 is traveling. When the vehicle 51 is loaded with freight, traveling is transporting.

Here, the measurement data is information with which it is possible to obtain information concerning moving speed and information concerning a direction and the magnitude of vibration due to acceleration based on, for example, the information concerning the acceleration, the information concerning the gyro, and the information concerning the position.

In the procedure P2, the measurement device 11 transmits the measurement data to the server device 12.

The server device 12 receives the measurement data.

In the procedure P3, when the driver of the vehicle 51 or the transportation company operates the first information processing device A1, the first information processing device A1 acquires loading rate information that is information concerning the size of the vehicle 51 and a loading rate of the vehicle 51.

In the present embodiment, the maximum loading capacity of the vehicle 51 is used as the size of the vehicle 51.

Here, for example, the driver of the vehicle 51 or the transportation company may input the size and the loading rate of the vehicle 51 to the first information processing device A1 or may designate the size and the loading rate of the vehicle 51 from a plurality of choices prepared in advance.

In the procedure P4, the first information processing device A1 transmits the acquired information concerning the size of the vehicle 51 and the loading rate of the vehicle 51 to the server device 12.

In the procedure P5, the report generation unit 131 of the server device 12 acquires the information concerning the size of the vehicle 51 and the loading rate of the vehicle 51 from the first information processing device A1.

The report generation unit 131 of the server device 12 stores the acquired measurement data and the acquired information concerning the size of the vehicle 51 and the loading rate of the vehicle 51 in the storage unit 114 in linkage with each other and generates labeled training data for machine learning.

A learning model is created by learning being performed using the labeled training data. The created learning model is a trained model.

As an example, labeled training data that can output a result classified into vehicle load weights of a plurality of stages such as a vehicle load weight of 0 [%], a vehicle load weight of 20 [%], a vehicle load weight of 40 [%], a vehicle load weight of 60 [%], a vehicle load weight of 80 [%], or a vehicle load weight of 100 [%] may be generated.

As another example, when it is sufficient to only determine whether the vehicle 51 is loaded with freight, the labeled training data may be generated only with information concerning whether the vehicle loading weight is 0 [%].

Here, in these examples, the vehicle load weight represents the weight of the freight loaded on the vehicle and represents the loading rate in percentage.

In the present embodiment, the loading rate is determined using a trained model that is a learned learning model.

Input data to the trained model is waveform data that is measurement data of the sensor provided in the measurement device 11 and the size of the vehicle 51.

Output data from the trained model includes information concerning the loading rate of the vehicle 51. The vehicle 51 is a vehicle driven by a driver corresponding thereto or a vehicle driven by a driver corresponding thereto.

Here, the information concerning the loading rate of the vehicle 51 included in the output data from the trained model may be, for example, information concerning a value of the loading rate itself or may be information representing to which of a plurality of ranges the value of the loading rate belongs.

The output data from the trained model is a value output by the trained model based on the input data.

In the present embodiment, a change in loading rate appears as a change in measurement data of one or more sensors provided in the measurement device 11.

For example, in general, the weight of a vehicle is represented by a function having acceleration in the up-down direction of the vehicle, speed of the vehicle, and a spring constant of the vehicle as parameters.

Here, for example, when the weight of things other than freight loaded on the vehicle can be regarded as constant, the weight of the vehicle changes according to the weight of the freight.

In present the embodiment, information representing the likelihood of a determination result of the loading rate may be output from the trained model together with a determination result of the loading rate.

As the information representing the likelihood of the determination result of the loading rate, for example, information based on a collation rate between waveform data input to the trained model and learned waveform data may be used.

Here, as another example, the information representing the likelihood of the determination result of the loading rate may be acquired by, for example, being calculated by a predetermined program other than the trained model.

Various aspects may be used as the input data and the output data of the trained model of the machine learning.

In addition, in the present embodiment, the loading rate of the vehicle 51 is determined from the measurement data using a learning model of machine learning. However, any method may be used as a method of determining the loading rate. The machine learning may not always be used.

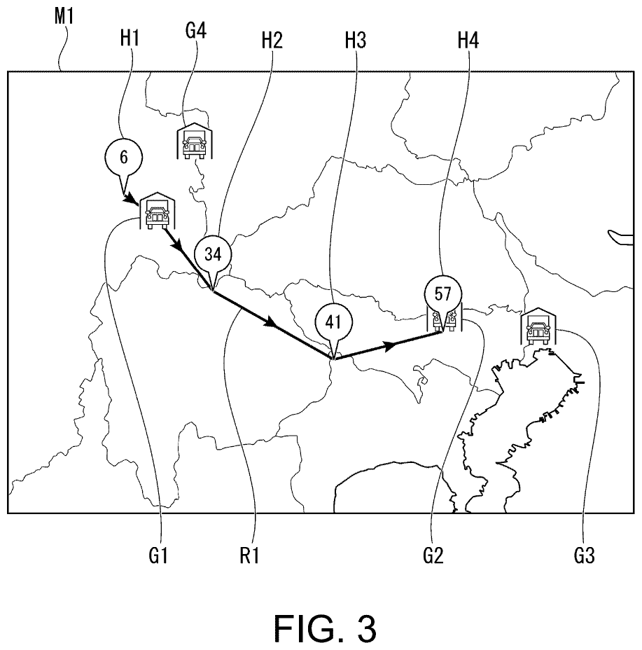

FIG. 3 is a diagram illustrating an example of a situation at the time of the movement of the vehicle 51 according to the embodiment.

In FIG. 3, a first map M1 is illustrated.

In the first map M1, a first base G1 to a fourth base G4, which are a plurality of bases, and a first route R1, which is a route along which the vehicle 51 has moved, are illustrated. The first route R1 is an example of a transportation route.

In addition, a 1-1-th position H1 to a 1-4-th position H4, which are positions on the first route R1 and are positions that the vehicle 51 has passed, are illustrated.

In this example, the vehicle 51 has moved along the first route R1 in a direction from the 1-1-th position H1 toward the 1-4-th position H4.

In the example illustrated in FIG. 3, a numerical value indicating each of the positions is illustrated in each of the 1-1-th position H1 to the 1-4-th position H4 but is not limited to this example.

Here, in the present embodiment, each of the bases represents a base for the vehicle 51 to transport freight. The base explained above may be set in advance by, for example, a transportation company that causes a driver to transport the freight.

When a plurality of bases are present, some bases that the vehicle 51 should pass in a transportation route at each time of the vehicle 51 among the plurality of bases may be set according to the transportation route at each time.

Note that transportation may be called, for example, transport or delivery.

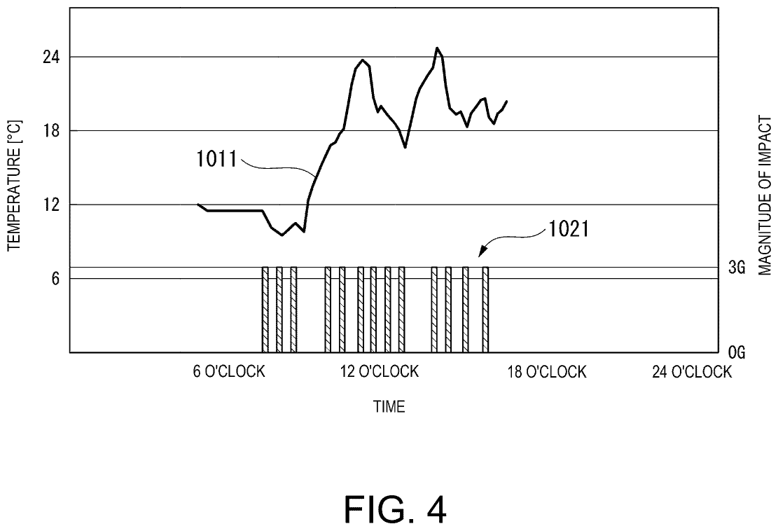

FIG. 4 is a diagram illustrating an example of temperature and the magnitude of an impact measured at the time of the movement of the vehicle 51 according to the embodiment.

The example illustrated in FIG. 4 corresponds to the movement of the vehicle 51 illustrated in FIG. 3.

In a graph illustrated in FIG. 4, the horizontal axis represents time, the left vertical axis represents temperature [° C.], and the right vertical axis represents the magnitude of an impact [G]. In this example, the magnitude of the impact is represented by a G value. However, another unit may be used.

In FIG. 4, a first characteristic 1011, which is a characteristic of measured temperature, and a second characteristic 1021, which is a characteristic of measured magnitude of an impact, are illustrated.

The first characteristic 1011 is information obtained by fitting temporally discrete measurement values with a predetermined line.

The second characteristic 1021 is temporally discrete information.

Here, in the examples illustrated in FIGS. 3 and 4, the temperature and the magnitude of the impact measured by the measurement device 11 of the vehicle 51 are normal in the first route R1.

An aspect may be used in which, as to whether the temperature is normal or abnormal, for example, the temperature is determined as normal when the temperature is lower than a predetermined value and the temperature is determined as abnormal when the temperature exceeds the predetermined value. Here, for example, the temperature being the predetermined value may be included in a normal range or may be included in an abnormal range.

Similarly, as to whether the magnitude of the impact is normal or abnormal, for example, the magnitude of the impact is determined as normal when the magnitude of the impact is smaller than a predetermined value and the magnitude of the impact is determined as abnormal when the magnitude of the impact exceeds the predetermined value. Here, for example, the magnitude of the impact being the predetermined value may be included in a normal range or may be included in an abnormal range.

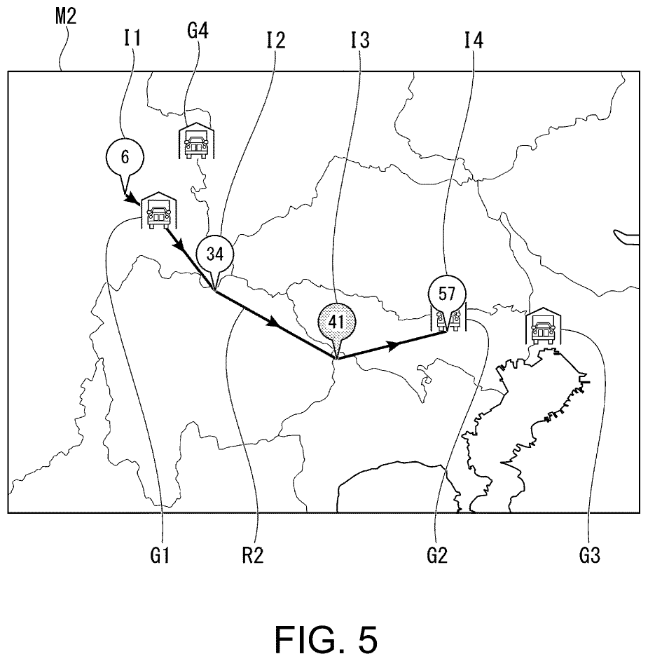

FIG. 5 is a diagram illustrating another example of the situation at the time of the movement of the vehicle 51 according to the embodiment.

In FIG. 5, a second map M2 is illustrated. In this example, the second map M2 shows the same region as the region shown in the first map M1 illustrated in FIG. 3.

In the second map M2, the first base G1 to the fourth base G4, which are the plurality of bases, and a second route R2, which is a route along which the vehicle 51 has moved, are illustrated. In this example, for convenience of explanation, the same bases as the bases illustrated in FIG. 3 are used as the first base G1 to the fourth base G4. In this example, for convenience of explanation, the same route as the first route R1 illustrated in FIG. 3 is used as the second route R2.

A 2-1-th position I1 to a 2-4-th position 14, which are positions on the second route R2 and are positions that the vehicle 51 has passed, are illustrated.

In this example, the vehicle 51 has moved along the second route R2 in the direction from the 2-1-th position I1 toward the 2-4-th position 14.

In the example illustrated in FIG. 5, a numerical value representing each of the positions is illustrated in each of the 2-1-th position I1 to the 2-4-th position 14 but is not limited to this example.

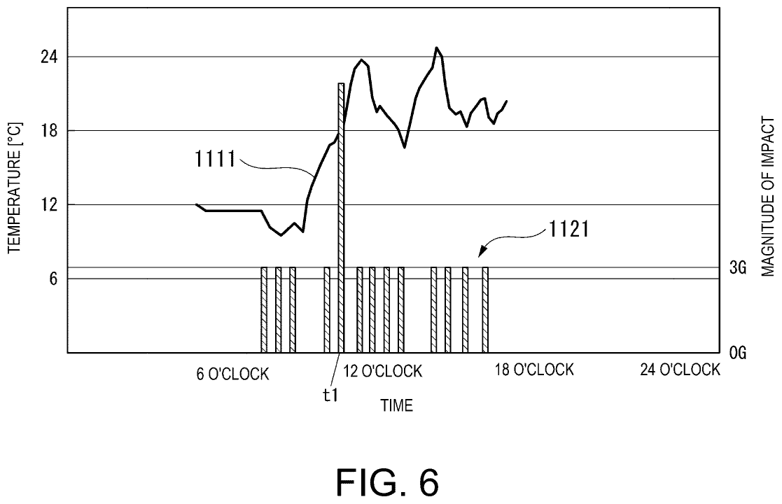

FIG. 6 is a diagram illustrating another example of the temperature and the magnitude of the impact measured at the time of the movement of the vehicle 51 according to the embodiment.

The example illustrated in FIG. 6 corresponds to the movement of the vehicle 51 illustrated in FIG. 5.

In a graph illustrated in FIG. 6, the horizontal axis represents time, the left vertical axis represents temperature [° C.], and the right vertical axis represents the magnitude of an impact [G]. In this example, the magnitude of the impact is represented by a G value. However, another unit may be used.

In FIG. 6, a third characteristic 1111, which is a characteristic of measured temperature, and a fourth characteristic 1121, which is a characteristic of the measured magnitude of an impact are shown.

The third characteristic 1111 is information obtained by fitting temporally discrete measurement values with a predetermined line.

The fourth characteristic 1121 is temporally discrete information.

Here, in the examples illustrated in FIGS. 5 and 6, an abnormality has occurred in the magnitude of an impact measured by the measurement device 11 of the vehicle 51 in the second route R2.

In the examples illustrated in FIGS. 5 and 6, the magnitude of the impact of the vehicle 51 is an abnormal value at the 2-3-th position 13 at first time t1. Here, in this example, when the magnitude of the impact exceeds a predetermined value, the magnitude of the impact is determined as abnormal.

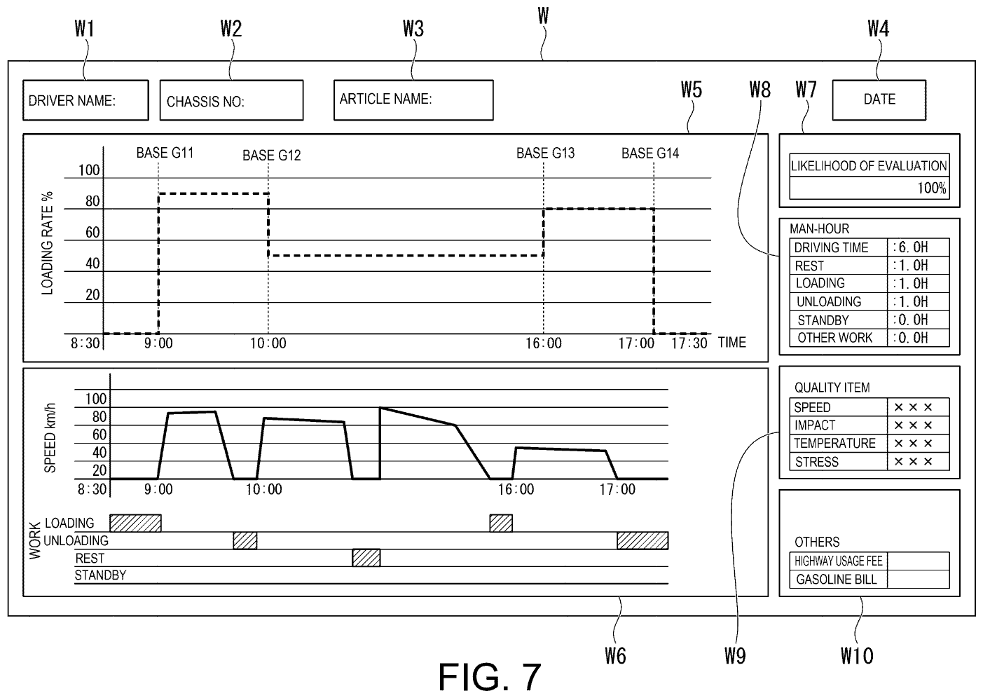

FIG. 7 is a diagram illustrating an example of a report W according to the embodiment.

In this example, the report W includes a first information region W1 to a tenth information region W10, which are a plurality of information regions.

In this example, the first information region W1 to the tenth information region W10 are divided on the inner side of a rectangular entire region of the report W.

Here, in this example, when the operator or the like logs in to a predetermined system provided in the first information processing device A1, the report W provided by the system is output. As an aspect of the output, for example, an aspect may be used in which information concerning the report W is displayed on a screen of the first information processing device A1 or an aspect may be used in which the information concerning the report W is printed on a medium by the printing device A2. The medium may be, for example, paper.

In this example, the predetermined system may be a system t provides a daily report concerning transportation performed by the driver.

The first information region W1 is a region where information concerning a driver name, which is a name of the driver, is stored.

Here, the information concerning the driver name is automatically input, for example, when the predetermined system is logged in.

As the driver name, a name of a driver who is a target of a daily report to be output is input.

The driver name may be, for example, manually input to the first information processing device A1 by the operator or the like.

The operator or the like who operates the first information processing device A1 may be a driver or a transportation company.

The second information region W2 is a region where information concerning a chassis No. representing a chassis number is stored.

Here, as the chassis number, for example, an identification number of a chassis is input.

The chassis number is an example of identification information of the chassis 61.

The third information region W3 is a region where information concerning a product name is stored.

As the information concerning the product name, information concerning a product name of freight transported by the driver is written.

Here, for example, in the third information region W3, information concerning an article may be stored together with information concerning a name of the article. As another example, the third information region W3 may be used as a region where the information concerning the article is stored instead of the article name. For example, an aspect may be used in which the information concerning the article is not displayed in the report W and the information concerning the article is grasped by the report generation unit 131 or the like.

Examples of the article include a precision machine, frozen food, refrigerated food, and a living thing.

In this example, a standard of quality control concerning the ninth information region W9 is different depending on the articles described above.

In the report providing system 1, for example, the article name and the article may be automatically input based on the delivery information or may be manually input.

The fourth information region W4 is a region where information concerning a date is stored.

Here, as the date, for example, a date when transportation was performed is input.

The fifth information region W5 is a region where information concerning a loading rate [%] is stored.

Here, in the fifth information region W5, information concerning a graph in which the horizontal axis represents time and the vertical axis represents the loading rate is stored. The horizontal axis represents elapse of time.

In the example illustrated in FIG. 7, the information concerning the graph is information in which loading rates determined using a predetermined trained model are illustrated in time series. In the graph, an eleventh base G11 to a fourteenth base G14, which are four bases, are illustrated.

Here, whether the vehicle 51 is present at each of the eleventh base G11 to the fourteenth base G14 is specified based on position information of the vehicle 51.

In the example illustrated in FIG. 7, a change in the loading rate in each of the eleventh base G11 to the fourteenth base G14 is illustrated.

By viewing the information concerning the graph, a viewer such as the operator can check, for example, at which loading rate the vehicle 51 driven by a driver has performed transportation.

In the example illustrated in FIG. 7, the loading rate is 90% between 9:00 and 10:00, the loading rate is 50% between 10:00 and 16:00, and the loading rate is 80% between 16:00 and 17:00. In the example illustrated in FIG. 7, the loading rate is particularly low between 10:00 and 16:00.

For example, a driver or a transportation company can achieve efficiency of transportation by examining the improvement of the loading rate.

As in the example illustrated in FIG. 7, the information concerning the loading rates may be displayed, based on the position information acquired by the sensor, in linkage with the bases set in advance. In this case, it is possible to display, based on a base, how the loading rate has changed.

The sixth information region W6 is a region where information concerning speed [km/h] and information concerning work are stored.

Here, in the sixth information region W6, information concerning a graph in which the horizontal axis represents time and the vertical axis represents speed is stored. The horizontal axis represents elapse of time.

In the example illustrated in FIG. 7, the information concerning the graph is information in which the speed of the vehicle 51 acquired based on measurement data of a sensor is indicated in time series.

In the sixth information region W6, information for specifying a type such as loading, unloading, resting, and standby is stored as types of work.

In the example illustrated in FIG. 7, the information concerning the type is information in which the types of work are indicated in time series.

Here, in this example, the work is information in which results of determination based on the information concerning speed and the information concerning the loading rate are indicated in time series.

For example, the loading rate is 0 [%] between 8:30 and 9:00 but the loading rate is 90 [%] after 9:00. Accordingly, the report generation unit 131 determines that loading was performed between 8:30 and 9:00.

The loading rate decreases from 90 [%] to 50 [%] after 10:00. Accordingly, the report generation unit 131 determines that unloading was performed at a time when the vehicle 51 was stopped around 10:00 and indicates the time when the vehicle 51 was stopped as an unloading time.

In this example, the vehicle 51 is regarded as being stopped when the speed of the vehicle is 0 [km/hour].

The vehicle 51 is stopped in a period of 10:00 to 16:00 but the loading rate does not change before and after the period. Accordingly, the report generation unit 131 determines that the driver is taking a rest at this time and indicates the time as a rest time.

Both of unloading work and loading work are sometimes performed in one base. In this case, the report generation unit 131 can determine, based on how waveform data added to the sensor changed, whether both of the unloading work and the loading work were performed.

That is, when the unloading or the loading is performed, since a person carries freight while getting on and off the loading platform 62, an impact is detected by the sensor when the person gets on and off. For example, when the unloading is performed, since the loading platform 62 gradually decreases in weight, the impact applied to the sensor tends to be larger at the end of the unloading than at the start of the unloading. Conversely, when the loading is performed, since the loading platform 62 gradually increases in weight, the impact applied to the sensor tends to be smaller at the end of loading than at the start of loading. By using this characteristic, when both waveform data in which the impact applied to the sensor gradually increases and waveform data in which the impact applied to the sensor gradually decreases are detected, the report generation unit 131 can also indicate that both of the unloading work and the loading work were performed.

Here, in the example illustrated in FIG. 7, in the report W, the fifth information region W5 where the loading rate information is stored and the sixth information region W6 where the speed information is stored are arranged adjacent to each other in the up-down direction.

Note that, in the example illustrated in FIG. 7, the positions of the times on the horizontal axis of the loading rate information and the speed information are different from each other. However, as another example, the positions of the times on the horizontal axis of the loading rate information and the speed information may be aligned to match each other. Accordingly, it is possible to make it easier to, for example, visually grasp association.

In the example illustrated in FIG. 7, the fifth information region W5 is arranged on the upper side and the sixth information region W6 is arranged on the lower side. However, as another example, the arrangements of the regions on the upper side and the lower side may be reversed.

A relationship between the arrangement positions of the fifth information region W5 and the sixth information region W6 may not always be the up and down relationship and may be any relationship such as a left and right relationship.

The seventh information region W7 is a region where information concerning the likelihood of evaluation is stored.

This information is an item indicating the likelihood of loading rate evaluation in the fifth information region W5.

In this example, the likelihood of the loading rate evaluation is a better value as a collation rate between acquired waveform data and learned waveform data is higher. Conversely, the likelihood is a worse value as the collation rate is lower.

The eighth information region W8 is a region where information concerning man-hours is stored.

Here, in the eighth information region W8, required times for each of types such as driving time, rest, loading, unloading, standby, and other work serving as types of the man-hours are stored.

In this example, in the man-hours, a total time of work evaluated by speed and work in the sixth information region W6 is illustrated.

In the example illustrated in FIG. 7, a unit [H] represents a time [hour].

The ninth information region W9 is a region where information concerning quality items is stored.

Here, in the ninth information region W9, required values for each of types such as speed, impact, temperature, and stress serving as types of the quality items are stored.

In this example, the quality items are items obtained by evaluating the quality of transportation based on the article in the third information region W3, the loading rate evaluation in the fifth information region W5, and the speed and the work in the sixth information region W6.

A case in which a quality item is speed is explained.

In this example, the quality item of the speed is an item for evaluating whether driving speed conforms to a standard. This standard may be different depending on, for example, a loading rate.

As a specific example, when the loading rate is high, an impact is more easily applied to the loading platform 62 compared with when the loading rate is low. For this reason, when the loading rate is high, it is necessary to reduce the speed of the vehicle 51 and drive the vehicle 51 more safely than when the loading rate is low. Therefore, maximum speed serving as an evaluation standard in the case in which the loading rate is high is lower than maximum speed serving as an evaluation standard at the time when the loading rate is low. For example, when actual speed exceeds the maximum speed explained above, the evaluation is low and, when the actual speed is equal to or lower than the maximum speed, the evaluation is high.

The maximum speed may be called, for example, MAX speed.

A case in which the quality item is an impact is explained.

In this example, whether an impact such as sudden braking is applied to the loading platform 62 is evaluated and, when there is an impact, the evaluation is low.

In the present embodiment, as a method of acquiring a value of the impact, for example, a method of acquiring a value of the impact based on measurement data of an acceleration sensor may be used. In this method, for example, a result obtained by dividing the magnitude of acceleration by a predetermined value is acquired as the value of the impact. The predetermined value is 9.81 [m/(second)²].

For example, the report generation unit 131 may record the value of the impact in linkage with the position of the vehicle 51 and present information indicating which transportation route has a problem.

For example, as in the examples illustrated in FIGS. 3 and 4, the report generation unit 131 determines that a situation is good when a large impact value is not applied.

On the other hand, for example, as in the examples illustrated in FIGS. 5 and 6, in a situation in which a large impact value occurred even once, the report generation unit 131 determines that a situation is bad. In this case, the report generation unit 131 may notify, for example, a position where the large impact value occurred and the magnitude of the impact.

The position may be called point where the large impact value occurred.

As to whether the value of the impact is large, for example, the value of the impact may be determined large when the value of the impact exceeds a predetermined value.

A case in which the quality item is temperature is explained.

In this example, whether the temperature is correctly managed is evaluated by a temperature sensor attached to the loading platform 62 of the vehicle 51. A main target of this evaluation is a case in which the article in the third information region W3 is refrigerated food or frozen food.

When the loading rate is high, since freight is more than when the loading rate is low, the inside of the loading platform 62 is less easily cooled. For this reason, temperature set when the loading rate is high may be set to be lower than temperature set when the loading rate is low. In this regard, for example, the report generation unit 131 determines that evaluation is low when temperature setting is not based on the loading rate and, conversely, determines that the evaluation is high when the temperature setting is based on the loading rate.

The evaluation may be performed considering, for example, outside air temperature, the number of times of door opening and closing, and an opening time besides the loading rate.

The outside air temperature may be detected by a temperature sensor. The temperature sensor may be provided in, for example, the sensor of the measurement device 11. The outside air temperature or the like may be determined from information obtained by the temperature sensor.

The server device 12 may determine the outside air temperature or the like based on position information acquired by the sensor and based on weather information concerning a position indicated by the position information.

The number of times of door opening and closing and the opening time may be detected with, for example, the acceleration of the sensor and the movement of a gyro. The temperature of the loading platform 62 is regarded as rising as the number of times of opening and closing is larger. When a door of the loading platform 62 is open, the temperature of the loading platform 62 rises.

As explained above, the temperature may be indirectly evaluated from information other than the temperature.

A case in which the quality item is stress is explained.

A main target of evaluation of the stress is a time when the article in the third information region W3 is a living thing.

Here, unlike other freight, if the loading rate is set too high, the living thing is rather stressed. Therefore, when the living thing is transported by the vehicle 51, it is preferable to set the loading rate lower than the loading rate for the other freight and, for example, set the loading rate to 50%. In this case, the report generation unit 131 determines that the evaluation is low when the loading rate exceeds this standard and determines that the evaluation is high when the loading rate is equal to or smaller than the standard.

A sound detection device may be attached to the loading platform 62 and the evaluation may be performed from a frequency, volume, and the like of a cry of the living thing at the time of transportation.

For example, when the frequency of the cry of the living thing is high or when the cry of the living thing is large, the report generation unit 131 may estimate and evaluate that the living thing is stressed.

Furthermore, for example, the report generation unit 131 may determine stress on the living thing from temperature, speed, and an impact during the driving.

As the sound detection device, for example, a sound sensor is used.

The tenth information region W10 is a region where other information is stored.

Here, in the tenth information region W10, as the other types, required expenses for each of types such as a highway usage fee and a gasoline bill at the time of transportation are stored.

In this example, the other information is information concerning expenses required at the time of transportation.

The highway usage fee is a toll road usage fee.

As information concerning the highway usage fee, for example, information manually input by a driver or the like may be reflected or information automatically acquired from predetermined equipment mounted on the vehicle 51 may be reflected. The predetermined equipment is, for example, an in-vehicle device adapted to an electronic toll collection system (ETC).

As an example, the information concerning the highway usage fee may be manually input to the first information processing device A1 by the driver or the like and notified from the first information processing device A1 to the server device 12.

As another example, the information concerning the highway usage fee may be notified from predetermined equipment mounted on the vehicle 51 to the server device 12 via a predetermined base station device and a predetermined network. The predetermined base station device and the predetermined network may be, for example, the base station device D1 and the network 81 or may be another base station device and another network.

The gasoline bill is a price of gasoline supplied by the vehicle 51 at a gas station at the time of driving.

As information concerning the gasoline bill, for example, information manually input by the driver or the like may be reflected or information automatically acquired from, for example, a buying and selling record of gasoline using a predetermined credit card may be reflected.

As an example, information concerning the gasoline bill may be manually input to the first information processing device A1 by the driver or the like and notified from the first information processing device A1 to the server device 12.

Here, since the price of refueling at the gas station has a price difference depending on a region and also affects a profit, the transportation company can use the price as a reference for examining further improvement in efficiency by recording the price as an item.

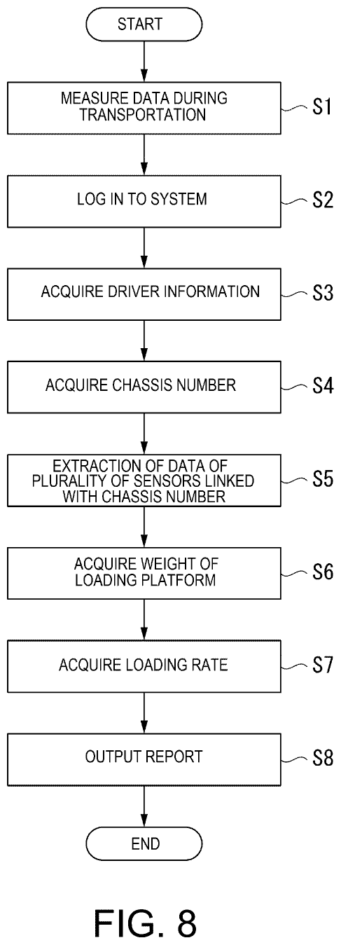

FIG. 8 is a diagram illustrating an example of a procedure of processing performed in the report providing system 1 according to the embodiment.

In the example illustrated in FIG. 8, processes of processing in steps S1 to S8 are illustrated.

A processing flow illustrated in FIG. 8 is an example and another processing flow may be used.

In step S1, in the report providing system 1, the measurement device 11 measures predetermined data during transportation of the vehicle 51 transporting freight. The measured data is recorded in the server device 12.

Here, in the present embodiment, the measurement device 11 including the sensor is attached to the chassis 61 of the vehicle 51.

In the server device 12, an identification number of the sensor is stored in the storage unit 114 in linkage with an identification number of the chassis 61 to which the measurement device 11 is attached.

Information concerning the linkage explained above may be input to the first information processing device A1 and input to the server device 12 via the first information processing device A1 by operation of the operator or the like.

For example, instead of an identification information of an individual sensor, for example, an identification information of the measurement device 11 may be used.

The identification information may be called ID or the like.

In the measurement device 11, for example, data of acceleration, data of a gyro, and data of a position are acquired by respective sensors at any time.

An acquisition interval of the respective data may be optional and may be, for example, a time interval of every one second, a time interval of every one minute, or another time interval.

The measurement device 11 stores the acquired data in a memory on the inside of the measurement device 11 and transmits the acquired data to the server device 12 at predetermined timing, for example, periodically.

Here, a time interval of transmitting the data from the measurement device 11 to the server device 12 is not particularly limited and may be, for example, the same as the time interval of acquiring the data with the sensors or may be a time interval longer than the time interval of acquiring the data with the sensors.

As a specific example, the time interval of transmitting the data from the measurement device 11 to the server device 12 may be, for example, a time interval of once in one hour.

The transmitting the data from the measurement device 11 to the server device 12 may be called, for example, upload.

In step S2, the report providing system 1 logs in to a predetermined system.

At this time, in the present embodiment, the transportation company or the like performs operation for logging in to the predetermined system.

The predetermined system may be, for example, a daily report output system that outputs information concerning a daily report concerning transportation.

In the present embodiment, a driver is specified from identification information at the time of the login.

In step S3, the report providing system 1 acquires driver information of the vehicle 51.

Here, as explained about step S2, the driver information, which is the information concerning the driver of the vehicle 51, is acquired.

In step S4, the report providing system 1 acquires information concerning a chassis number of the vehicle 51.

Here, the chassis number is a chassis number of the chassis 61 incidental to the vehicle 51 driven by the driver.

Here, for example, the chassis number may be manually input by a driver or the like in the report providing system 1 or the chassis number may be automatically acquired based on delivery information linked with the driver managed by the server device 12.

In the present embodiment, the delivery information includes information concerning the chassis 61 of the vehicle 51 driven by the driver and the information includes information concerning the chassis number.

The chassis number may be called, for example, chassis No.

The information of the chassis number acquired in step S4 may be used as, for example, the information concerning the chassis number illustrated in FIG. 7.

In step S5, the report providing system 1 extracts data of a plurality of sensors linked with the acquired chassis number.

In the present embodiment, the report providing system 1 extracts data of a sensor of the measurement device 11 attached to the chassis 61 corresponding to the acquired chassis number.

In this example, the plurality of sensors are used in the vehicle 51. However, as another example, when one sensor is used, data of the sensor is extracted in step S5.

In step S6, the report providing system 1 acquires information concerning the weight of the loading platform 62 of the vehicle 51 driven by the driver.

Here, for example, the weight of the loading platform 62 may be manually input by the driver or the like in the report providing system 1 or the weight of the loading platform 62 may be automatically acquired based on delivery information linked with the driver managed by the server device 12.

In the present embodiment, the delivery information includes information concerning the loading platform 62 of the vehicle 51 driven by the driver and the information includes information concerning the weight of the loading platform 62.

In this example, for example, information concerning the maximum loading capacity of the loading platform 62 of the vehicle 51 may be used as the information concerning the weight of the loading platform 62.

In step S7, the report providing system 1 acquires information concerning a loading rate using a predetermined trained model.

In the present embodiment, for example, measurement data of the sensor of the measurement device 11 and information concerning a size are input to the trained model and the information concerning the loading rate is output from the trained model.

In the present embodiment, the information concerning the maximum loading capacity of the loading platform 62 of the vehicle 51 is used as the information concerning the size.

In step S8, the report providing system 1 outputs information concerning a report in which the loading rate is described.

As a process of processing between the processing in step S7 and the processing in step S8, for example, the report providing system 1 may perform processing of determining a type of work of the driver, processing of determining quality, and the like.

In the example illustrated in FIG. 8, the processing flow focusing on the loading rate is explained. However, the report providing system 1 acquires all information described in the report to be output.

As the report, for example, the report W illustrated in FIG. 7 may be used or a report of another format or another content may be used.

As a specific example, compared with the report W illustrated in FIG. 7, the report may not include a part of information included in the report W or may include other information not included in the report W.

Arrangement positions of the pieces of information in the report is not limited to the arrangement positions in the report W illustrated in FIG. 7 and any arrangement positions may be used.

As explained above, in the report providing method and the control method for the report providing system 1 according to the present embodiment, the server device 12 determines the loading rate of the vehicle 51 based on the detection value by the sensor of the measurement device 11 attached to the vehicle 51 and the information concerning the size of the vehicle 51 and presents the report W in which the information concerning the determined loading rate is described.

Therefore, in the report providing method and the control method for the report providing system 1 according to the present embodiment, it is possible to urge efficiency of the loading rate by notifying the loading rate of the vehicle 51 to the driver or the transportation company.

Accordingly, in the report providing method and the control method for the report providing system 1 according to the present embodiment, for example, it is possible to provide sufficient information as transportation information that can be used for management determination for the transportation company, transportation quality information for a shipper, or the like. For example, the transportation company or the like can contribute to business by reviewing the loading rate.

In the report providing method and the control method for the report providing system 1 according to the present embodiment, for example, a driving daily report in which the item concerning the loading rate is described can be generated as the report W.

In the present embodiment, it is possible to provide information that can contribute to efficiency of distribution or quality of transportation more using a sensor.

Configuration examples according to the present embodiment are explained.

As a configuration example, a report providing method for providing the report W concerning the vehicle 51 to which the sensor is attached is configured as explained below.

The report W includes loading rate information concerning a loading rate of the vehicle 51 calculated based on data concerning the vehicle 51 detected by the sensor and the maximum loading capacity of the vehicle 51.

A computer performs a step of acquiring the report W including the loading rate information and a step of displaying or printing the report W on a medium.

Therefore, in the report providing method, it is possible to urge efficiency of the loading rate by notifying the loading rate of the vehicle 51 to the driver or the transportation company.

Here, in the present embodiment, the sensor is a sensor of the measurement device 11.

For example, only any one of the processing of displaying the report W and the processing of printing the report W may be configured to be able to be performed or both of these kinds of processing may be configured to be able to be performed.

In the present embodiment, the computer is a combination of a computer configuring the server device 12, a computer configuring the first information processing device A1, and a computer configuring the printing device A2. However, for example, these computers may be configured as one computer or the server device 12 and the first information processing device A1 may be configured as one computer and the printing device A2 may be provided. When the printing of the report W is unnecessary, the printing device A2 may not be provided.

As another example, a function of performing the steps explained above may be provided in a computer such as a smartphone or a tablet terminal carried by the driver or the like instead of the computer such as the server device 12 according to the present embodiment.

As a configuration example, the report providing method is configured as explained below.

Data concerning the vehicle 51 is data concerning an impact that occurs when the vehicle 51 moves.

Therefore, in the report providing method, a loading rate calculated according to the impact can be provided to the driver or the transportation company.

As a configuration example, the report providing method is configured as explained below.

The loading rate information is information indicating a change in the loading rate in elapse of time.

Therefore, in the report providing method, a change in the loading rate in the elapse of time can be provided.

As a configuration example, the report providing method is configured as explained below.

The sensor acquires position information of the vehicle 51.

In the report providing method, whether the vehicle 51 is present in a base is specified from the position information.

The loading rate information is information indicating a change in the loading rate in the base.

Therefore, in the report providing method, a change in the loading rate in elapse of time can be provided concerning the loading rate in the base.

As a configuration example, the report providing method is configured as explained below.

The report W includes evaluation corresponding to a collation rate of loading rate information calculated based on data acquired by the sensor.

Therefore, in the report providing method, likelihood of evaluation of the loading rate information can be provided.

Here, in the present embodiment, the information concerning the likelihood of the evaluation in the seventh information region W7 illustrated in FIG. 7 is an example of the evaluation corresponding to the collation rate of the loading rate information.

As a configuration example, the report providing method is configured as explained below.

The report W includes speed information concerning speed of the vehicle 51 calculated from the data acquired by the sensor.

Therefore, in the report providing method, the speed information can be provided.

As a configuration example, the report providing method is configured as explained below.

The sensor acquires speed information of the loading platform 62 of the vehicle 51.

The report W includes a speed evaluation item obtained by evaluating the speed of the vehicle 51 corresponding to the loading rate.

Therefore, in the report providing method, speed evaluation corresponding to the loading rate can be provided.

Here, in the example illustrated in FIG. 7, in the report W, the fifth information region W5 where the loading rate information is stored and the sixth information region W6 where the speed information is stored are arranged adjacent to each other in the up-down direction. Accordingly, it is visually easy to perform the speed evaluation corresponding to the loading rate.

In the present embodiment, the measurement device 11 is provided in the chassis 61 of the vehicle 51 and directly acquires speed information of the chassis 61. However, the speed information is regarded as being the same or substantially the same as the speed information of the loading platform 62 of the vehicle 51. As another example, a sensor may be provided in the loading platform 62 of the vehicle 51 and speed information of the loading platform 62 may be directly measured.

As a configuration example, the report providing method is configured as explained below.

The sensor acquires temperature information of the loading platform 62 of the vehicle 51.

The report W includes a temperature evaluation item obtained by evaluating the temperature of the loading platform 62 of the vehicle 51 corresponding to the loading rate.

Therefore, in the report providing method, temperature evaluation corresponding to the loading rate can be provided.

Here, in the present embodiment, the item in which the quality item in the ninth information region W9 illustrated in FIG. 7 is temperature is an example of the temperature evaluation item.

As a configuration example, the report providing method is configured as explained below.

The report W includes an article conveyed by the vehicle 51 and, when the article is a living thing, includes a stress evaluation item obtained by evaluating stress on the living thing corresponding to the loading rate.

Therefore, in the report providing method, stress evaluation on the living thing corresponding to the loading rate can be provided.

Here, in the present embodiment, the item in which the quality item in the ninth information region W9 illustrated in FIG. 7 is stress is an example of the stress evaluation item.

As a configuration example, the control method for the report providing system 1 is configured as explained below.

The report providing system 1 includes the sensor attached to the vehicle 51, the report generation unit 131 that generates the report W based on data detected by the sensor, and the report output unit that outputs the report generated by the report generation unit 131.

The control method for the report providing system 1 includes a step of causing the sensor to acquire data concerning the vehicle 51, a step of causing the sensor to transmit the acquired data to the report generation unit 131, a step of causing the report generation unit 131 to acquire a maximum loading capacity of the vehicle 51, and a step of causing the report generation unit 131 to calculate a loading rate of the vehicle 51 based on the data and the maximum loading capacity.

The control method for the report providing system 1 includes a step of causing the report generation unit 131 to generate the report W including loading rate information concerning the calculated loading rate of the vehicle 51, a step of causing the report generation unit 131 to transmit the generated report W to the report output unit, and a step of causing the report output unit to display the report W or print the report W on a medium.

Therefore, in the control method for the report providing system 1, it is possible to urge efficiency of the loading rate by notifying the loading rate of the vehicle 51 to the driver or the transportation company.

Here, in the present embodiment, one or more of the report output unit 132 of the server device 12, the first report output unit C1 of the first information processing device A1, and the second report output unit C2 of the printing device A2 are examples of the report output unit.

Data communication from the sensor to the report generation unit 131 may be performed via, for example, another device or another processing unit.

Data communication from the report generation unit 131 to the report output unit may be performed via, for example, another device or another processing unit.

A program for implementing the function of any constituent unit in any device explained above may be recorded in a computer-readable recording medium and the program may be executed by causing a computer system to read the program. The “computer system” referred to here includes an operating system or hardware such as peripheral equipment. The “computer-readable recording medium” is a portable medium such as a flexible disc, a magneto-optical disc, a read only memory (ROM), or a compact disc (CD)-ROM or a storage device such as a hard disk incorporated in the computer system. The “computer-readable recording medium” includes a recording medium that retains a program for a certain period of time like a volatile memory on the inside of the computer system serving as a server or a client when the program is transmitted via a network such as the Internet or a communication line such as a telephone line. The volatile memory may be a RAM. The recording medium may be a non-transitory recording medium.

The program explained above may be transmitted from a computer system in which the program is stored in a storage device or the like to another computer system via a transmission medium or by a transmission wave in the transmission medium. The “transmission medium” for transmitting the program refers to a medium having a function of transmitting information like a network such as the Internet or a communication line such as a telephone line.

The program explained above may be a program for implementing some of the functions explained above. The program explained above may be a program that can implement the functions explained above in combination with a program already recorded on the computer system, a so-called differential file. The differential file may be called differential program.

The function of any constituent unit in any device explained above may be implemented by a processor. The kinds of processing in the embodiment may be implemented by a processor that operates based on information such as a program and a computer-readable recording medium that stores the information such as the program. In the processor, the functions of the units may be implemented by individual hardware or the functions of the units may be implemented by integrated hardware. The processor may include hardware and the hardware may include at least one of a circuit that processes a digital signal and a circuit that processes an analog signal. The processor may be configured using one or both of one or a plurality of circuit devices implemented on a circuit board and one or a plurality of circuit elements. An integrated circuit (IC) or the like may be used as the circuit device and a resistor, a capacitor, or the like may be used as the circuit element.

The processor may be a CPU. However, the processor is not limited to the CPU, and various processors such as a graphics processing unit (GPU) or a digital signal processor (DSP) may be used. The processor may be a hardware circuit by an application specific integrated circuit (ASIC). The processor may include a plurality of CPUs or may include a hardware circuit by a plurality of ASICS. The processor may include a combination of a plurality of CPUs and a hardware circuit by a plurality of ASICS. The processor may include one or more of an amplifier circuit, a filter circuit, and the like that process an analog signal.

While the embodiment is explained in detail above with reference to the drawings, a specific configuration is not limited to the embodiment and include design and the like in a range not departing from the gist of the present disclosure.

### Appendices

Configuration examples 1 to 10 are explained below.

A lower-order configuration example may or may not be applied to a higher-order configuration example.

A lower-order configuration example applicable to any one of two or more higher-order configuration examples may be applied to any configuration example among the two or more higher-order configuration examples and, when there are two or more application examples in this way, a configuration example lower in order than the lower-order configuration example may be applied to any application example among the two or more application examples.

### Configuration Example 1

A report providing method for providing a report concerning a vehicle to which a sensor is attached, the report including loading rate information concerning a loading rate of the vehicle calculated based on data concerning the vehicle detected by the sensor and a maximum loading capacity of the vehicle, the report providing method including a computer: acquiring including the loading rate information; and displaying the report or printing the report on a medium.

### Configuration Example 2

The report providing method described in the configuration example 1, wherein the data concerning the vehicle is data concerning an impact that occurs when the vehicle moves.

### Configuration Example 3

The report providing method described in the configuration example 1 or the configuration example 2, wherein the loading rate information is information indicating a change in the loading rate in elapse of time.

### Configuration Example 4

The report providing method described in any one of the configuration example 1 to the configuration example 3, wherein
the sensor acquires position information of the vehicle and specifies, from the position information, whether the vehicle is present in a base, and
the loading rate information is information indicating a change in the loading rate in the base.

### Configuration Example 5

The report providing method according to any one of the configuration example 1 to the configuration example 4, wherein the report includes evaluation corresponding to a collation rate of the loading rate information calculated based on the data acquired by the sensor.

### Configuration Example 6

The report providing method according to any one of the configuration example 1 to the configuration example 5, wherein the report includes speed information concerning speed of the vehicle calculated from the data acquired by the sensor.

### Configuration Example 7

The report providing method described in any one of the configuration example 1 to the configuration example 6, wherein
the sensor acquires speed information of a loading platform of the vehicle, and
the report includes a speed evaluation item obtained by evaluating speed of the vehicle corresponding to the loading rate.

### Configuration Example 8

The report providing method according to any one of the configuration example 1 to the configuration example 7, wherein
the sensor acquires temperature information of a loading platform of the vehicle, and
the report includes a temperature evaluation item obtained by evaluating temperature of the loading platform of the vehicle corresponding to the loading rate.

### Configuration Example 9

The report providing method according to any one of the configuration example 1 to the configuration example 8, wherein the report includes an article conveyed by the vehicle and, when the article is a living thing, includes a stress evaluation item obtained by evaluating stress on the living thing corresponding to the loading rate.

### Configuration Example 10

A control method for a report providing system including: a sensor attached to a vehicle; a report generation unit configured to generate a report based on data detected by the sensor; and a report output unit configured to output the report generated by the report generation unit,
the control method including:
causing the sensor to acquire data concerning the vehicle;
causing the sensor to transmit the acquired data to the report generation unit;
causing the report generation unit to acquire a maximum loading capacity of the vehicle;
causing the report generation unit to calculate a loading rate of the vehicle based on the data and the maximum loading capacity;
causing the report generation unit to generate the report including loading rate information concerning the calculated loading rate of the vehicle;
causing the report generation unit to transmit the generated report to the report output unit; and
causing the report output unit to display the report or print the report on a medium.

What is claimed is:

1. A report providing method for providing a report concerning a vehicle to which a sensor is attached,
the report including loading rate information concerning a loading rate of the vehicle calculated based on data concerning the vehicle detected by the sensor and a maximum loading capacity of the vehicle,
the report providing method comprising a computer:
acquiring the report including the loading rate information; and
displaying the report or printing the report on a medium.

2. The report providing method according to claim 1, wherein the data concerning the vehicle is data concerning an impact that occurs when the vehicle moves.

3. The report providing method according to claim 1, wherein the loading rate information is information indicating a change in the loading rate in elapse of time.

4. The report providing method according to claim 3, wherein
the sensor acquires position information of the vehicle and specifies, from the position information, whether the vehicle is present in a base, and
the loading rate information is information indicating a change in the loading rate in the base.

5. The report providing method according to claim 4, wherein the report includes evaluation corresponding to a collation rate of the loading rate information calculated based on the data acquired by the sensor.

6. The report providing method according to claim 5, wherein the report includes speed information concerning speed of the vehicle calculated from the data acquired by the sensor.

7. The report providing method according to claim 6, wherein
the sensor acquires speed information of a loading platform of the vehicle, and
the report includes a speed evaluation item obtained by evaluating speed of the vehicle corresponding to the loading rate.

8. The report providing method according to claim 5, wherein
the sensor acquires temperature information of a loading platform of the vehicle, and
the report includes a temperature evaluation item obtained by evaluating temperature of the loading platform of the vehicle corresponding to the loading rate.

9. The report providing method according to claim 5, wherein the report includes an article conveyed by the vehicle and, when the article is a living thing, includes a stress evaluation item obtained by evaluating stress on the living thing corresponding to the loading rate.

10. A control method for a report providing system including: a sensor attached to a vehicle; a report generation unit configured to generate a report based on data detected by the sensor; and a report output unit configured to output the report generated by the report generation unit,
the control method comprising:
causing the sensor to acquire data concerning the vehicle;
causing the sensor to transmit the acquired data to the report generation unit;
causing the report generation unit to acquire a maximum loading capacity of the vehicle;
causing the report generation unit to calculate a loading rate of the vehicle based on the data and the maximum loading capacity;
causing the report generation unit to generate the report including loading rate information concerning the calculated loading rate of the vehicle;
causing the report generation unit to transmit the generated report to the report output unit; and
causing the report output unit to display the report or print the report on a medium.
